(19) United States
(12) Patent Application Publication
(10) Pub. No.: US 2007/0081093 A1
(43) Pub. Date: Apr. 12, 2007

(54) AUTOMATIC FOCUSING CAMERA BASE

(75) Inventor: Te-An YIN, Taipei (TW)

Correspondence Address: PATENTTM.US, P. O. BOX 82788, PORTLAND, OR, 97282-0788, US

(73) Assignee: INCHAN TECHNOLOGY CO., LTD., Sindian City (TW)

(21) Appl. No.: 11/457,769

(22) Filed: Jul. 14, 2006

(30) Foreign Application Priority Data
Oct. 6, 2005 (TW) 094217277

(51) Int. Cl. G03B 13/00

(52) U.S. Cl. 348/345

(57) ABSTRACT

An automatic focusing camera base has a seat, a motor, a focusing device and a transmission device. The motor is mounted and horizontally lies on the seat and has a shaft. The focusing device is mounted on the seat and can move relative to the seat. The transmission device is mounted between the motor and the focusing device and has an active member mounted around the shaft and being movable along the shaft and a passive member mounted pivotally on the seat, abutting and driven by the active member to pivot and move the focusing device. The transmission device are designed especially to cooperate with and allow the motor to horizontally lie on the seat instead of upright standing and therefore a thickness of the automatic focusing camera base along a linear line perpendicular to an axis of the motor is reduced.

### BACKGROUND OF THE INVENTION

1. Field of the Invention

The present invention relates to a camera base, and particularly to an automatic focusing camera base that has a seat and a motor horizontally lying and mounted on the seat and is thin and compact.

2. Description of the Related Art

With reference to FIG. 8, a conventional camera base assembly has a base (90), a motor (91), a focusing member (92), a lens (93), a driving member (94) and an electrical circuit. The motor (91) is mounted uprightly on the base (90) and has a post (911) mounted rotatably in and extending out of the motor (91). The focusing member (92) is mounted movably on the base (90). The lens (93) is mounted on the focusing member (92). The central axis of the lens (93) is parallel to the central axis of the motor (91). The driving member (94) is mounted on the focusing member (92) and connects to the post (911) so that the post (911) can adjust the focusing member (92) via the motor (91). The electrical circuit. is connected to the motor (91).

However, the conventional camera with the upright motor (91) and the post (911) has a considerable thickness such that the mobile phone with the conventional camera is thick, incompact and has a considerable size and a bad marketability.

Therefore, the invention provides an automatic focusing camera base to mitigate or obviate the aforementioned problems.

### SUMMARY OF THE INVENTION

The main objective of the present invention is to provide an automatic focusing camera base an automatic focusing camera base that has a seat and a motor horizontally lying and mounted on the seat and is thin and compact.

An automatic focusing camera base in accordance with the present invention comprises a seat, a motor, a focusing device and a transmission device.

The motor is mounted and horizontally lies on the seat and has a shaft.

The focusing device is mounted on the seat and can move relative to the seat.

The transmission device is mounted between the motor and the focusing device and has an active member mounted around the shaft and being movable along the shaft and a passive member mounted pivotally on the seat, abutting and driven by the active member to pivot and move the focusing device.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of the automatic focusing camera base in accordance with this invention;

FIG. 2 is an exploded perspective view of the automatic focusing camera base in FIG. 1;

FIG. 3 is another exploded perspective view of the automatic focusing camera base in FIG. 1;

FIG. 4 is a partially exploded perspective view of the motor, the first and second conductive members and the active member of the camera base in FIG. 1;

FIG. 5 is a side view of the automatic focusing camera base in FIG. 1;

FIG. 6 is a cross sectional side view of the automatic focusing camera base in FIG. 4;

FIG. 7 is an operational cross sectional side view of the automatic focusing camera base in FIG. 5; and

FIG. 8 is a perspective view of a conventional camera base assembly in accordance with the prior art.

### DETAILED DESCRIPTION OF THE PREFERRED EMBODIMENT

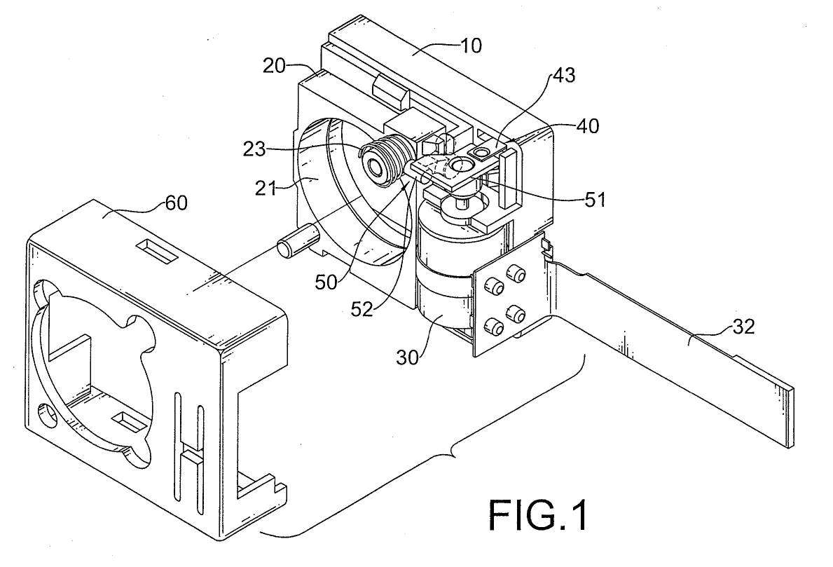

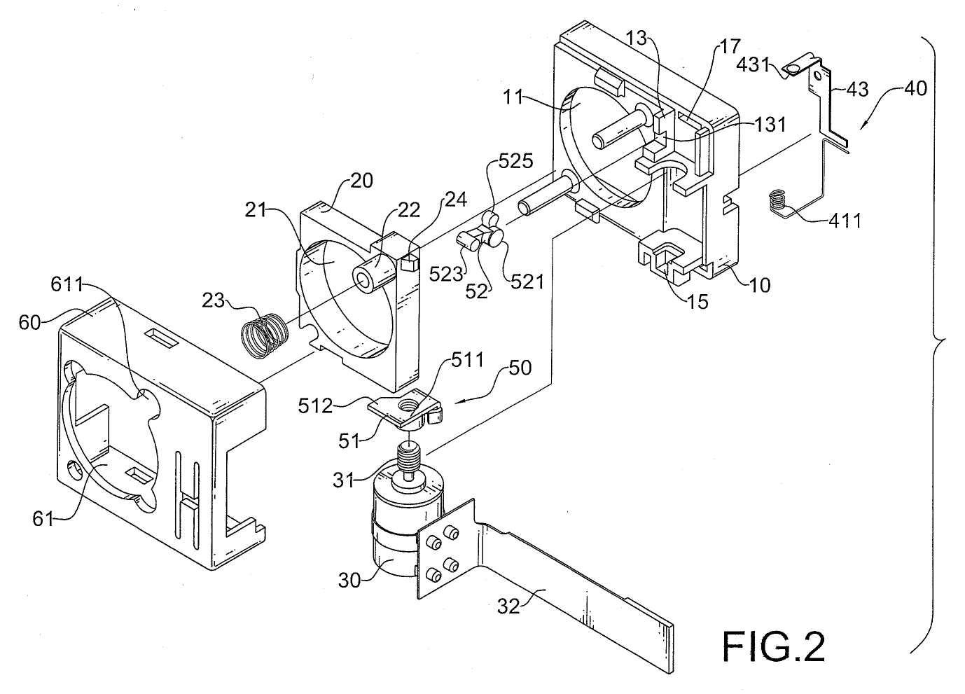

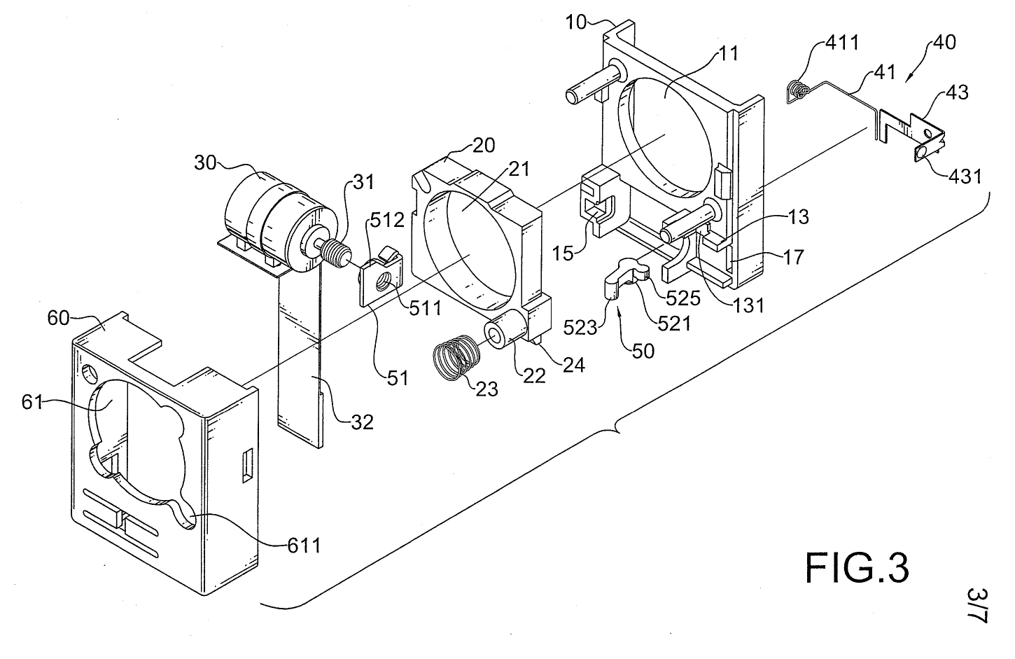

With reference to FIGS. 1-2, an automatic focusing camera base is adapted to be mounted with a lens, and is mounted in portable electric appliance such as a cell phone. The automatic focusing camera base has a seat (10), a motor (30), a focusing device (20), a contact set (40), a transmission device (50), and a cover (60).

The seat (10) includes a first lens hole (11) defined in the seat (10), a pivot seat (13) formed on the seat (10), two mounting holes (15, 17) defined respectively through two sides of the seat (10) and at least one rail rod protrudes from the seat (10). The pivot seat (13) has a pivot slot (131) defined the pivot seat (13).

With reference to FIGS. 2, 4 and 5, the motor (30) is mounted on and horizontally lies on the seat (10), and the motor (30) has an axis, a housing, a threaded shaft (31) and a conductive element. The axis is perpendicular to the at least one rail rod on the seat (10). The threaded shaft (31) is conductive, is perpendicular to the at least one rail rod on the seat (10), rotatably extends through and contacts the housing of the motor (30) and has two ends and may have an electric contact (33) formed on one end. The conductive element is attached to the motor (30), may be the housing and may be the electric contact (33) on the threaded shaft (31). The motor (30) is connected to a driving circuit (32), which is mounted on a thin film circuit board. The driving circuit (32) is further connected to a main control circuit, which controls the operation of the motor (30).

The focusing device (20) is mounted slidably on the at least one rail rod on the seat (10) and is movable along a linear line perpendicular to the axis of the motor (30). In addition, the focusing device (20) has a second lens hole (21) defined in the focusing device (20) and corresponding to the first lens hole (11), a protruding block (24) formed on an outer edge of the focusing device (20), and a post (22) formed on an outside surface of the focusing device (20) opposite to the seat (10). A spring (23) is mounted around the post (22).

The contact set (40) is mounted on the seat and connected to the motor (30) and is connected to a detecting circuit with a micro-controller and a signal source. The contact set (40) has a first conductive member (41) and a second conductive member (43), which are mounted on the seat (10) respectively through the mounting holes (15, 17). The first conductive member (41) is L-shaped, has a first end, a second end, a first contact (411). The first contact (411) is spring-shaped, is formed on the first end, is connected to the conductive element of the motor (30) and may be connected to the housing or the electric contact (33) on the threaded shaft (31). The second end of the first conductive member (41) is connected to the signal source being a 3 voltages (V) signal source mounted in the portable electric appliance. The second conductive member (43) is L-shaped, has a first end, a second end, a second contact (431) being a knob formed on the first end and aligned with the threaded shaft (31). The second end of the second conductive member (43) is connected to the micro-controller of the detecting circuit. When the threaded shaft (31) is connected electrically with the second contact (431) through the conductive element, the detective circuit is activated and the micro-controller receives the signal from the 3V signal source to make a zero adjustment to the focusing device (20). The position of the focusing device (20) is zeroed and is defined as an original point.

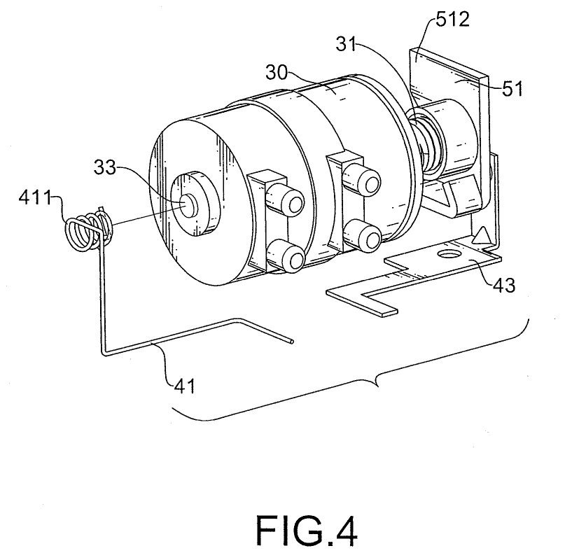

With reference to FIGS. 2 and 4, the transmission device (50) is mounted between the motor (30) and the focusing device (20) and is in response to the motor (30) to move the focusing device (20). The transmission device (50) has an active member (51) and a passive member (52).

The active member (51) is conductive, is a nut mounted around the threaded shaft (31), is movable along the threaded shaft (31) and selectively contacts the second contact (431) of the second conductive member (431). The nut has a threaded hole (511) defined through the nut and through which the threaded shaft (31) is mounted. In addition, a protrusion (512) protrudes from the active member (51). The passive member (52) is mounted pivotally on the seat (10), abuts the active member (51) and is driven by the active member (51) to pivot and move the focusing device (20). The passive member (52) is L-shaped and has a pivot member (521), a first arm, a second arm, a driven member (523) and a driving member (525). The first and second arms protrude from the pivot member (521) with a space between the first and second arms and through which the protrusion (512) of the active member (51) extends. Therefore, the passive member (52) is limited between the pivot seat (13) and the protrusion (512), so the passive member (52) can safely pivot on the seat (10) without a fastener such as a bolt or pin and never falls out of the seat (10). The pivot member (521) is formed on the passive member (52), may be formed between the two arms and is mounted rotatably in the pivot slot (131) in the pivot seat (13). The driven member (523) is formed on the passive member (52), may be formed in a distal end of the first arm and presses against the protrusion (512) of the active member (51). The driving member (525) is formed on the passive member (52), may be formed in a distal end of the second arm and presses against the protruding block (24) of the focusing device (20).

The cover (60) is mounted on the seat (10), covers the motor (30), the focusing device (20), the contact set (40) and the transmission device (50) and the cover (60) presses against the spring (23) around the post (22). The covet (60) has a third lens hole (61) defined through the cover (60) and an opening (611) defined through the cover (60) and through which the post (22) extends.

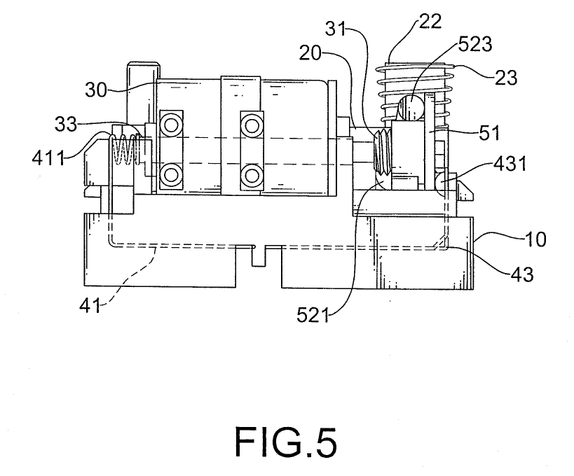

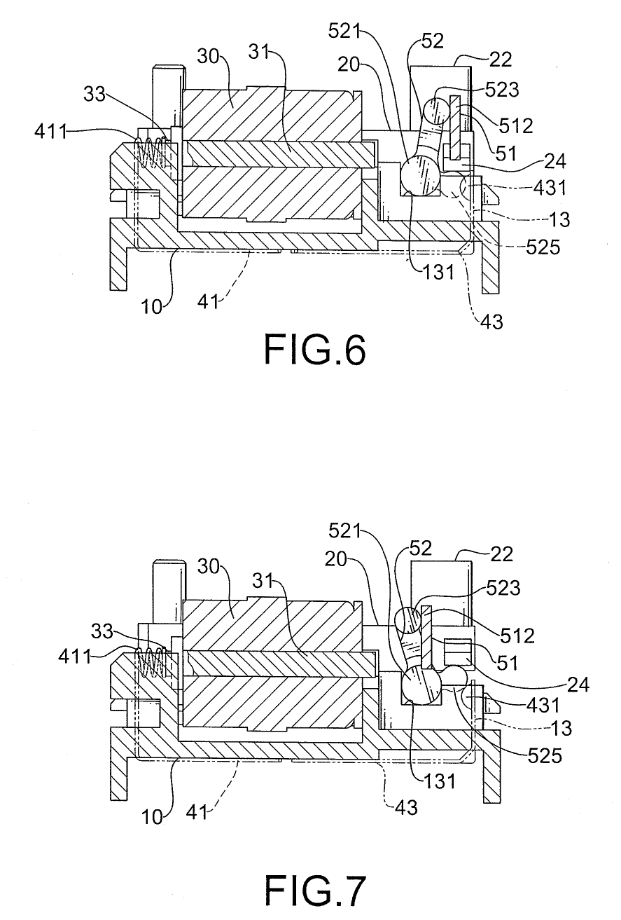

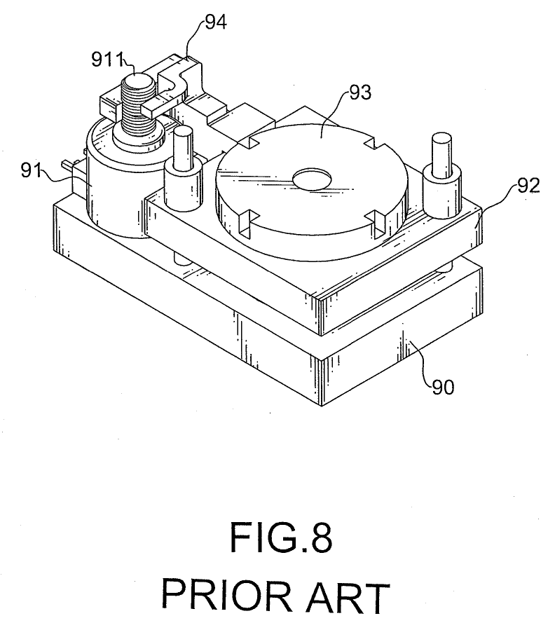

With reference to FIGS. 5 and 6, when the position of the focusing device (20) is about to be zeroed, the active member (51) contacts the second contact (431) of the second conductive member (43). The detecting circuit is activated and then the micro-controller receives signals from the 3V signal source and zeros the position of the focusing device (20).

With reference to FIG. 7, the motor (30) is driven by the main control circuit to rotate. The active member (51) is brought to be away from the second conductive member (43) and then the detecting circuit is cut off. The passive member (52) is pushed by the active member (51), so the focusing device (20) moves away from the seat (10). Meanwhile, the main control circuit calculates a displacement of the focusing device (20) according to the original position of the focusing device (20).

Besides driving the focusing device (20), the motor (30) and the active member (51) also cooperate to activate the detecting circuit for the zero adjustment of the focusing device (20) without a ray-emitter and a ray-interceptor. Therefore, the structure of the automatic focusing camera base is simple and compact as compared with a conventional camera base.

Furthermore, the transmission device (50) are designed especially to cooperate with and allow the motor (30) to horizontally lie on the seat (10) instead of upright standing. The lying motor (30) reduces a thickness of the automatic focusing camera base along the linear line perpendicular to the axis of the motor (30). Therefore, the automatic focusing camera base is thin and compact and a mobile apparatus such cellular phone equipped with the automatic focusing camera base becomes marketable.

What is claimed is:

1. An automatic focusing camera base comprising:
a seat having at least one rail rod protruding from the seat;
a motor mounted and horizontally lying on the seat and having an axis and a shaft;
a focusing device slidably mounted on the at least one rail rod on the seat and being movable along a linear line perpendicular to the axis of the motor; and
a transmission device mounted between the motor and the focusing device, being in responsive to the motor to move the focusing device and having
an active member being conductive, mounted around the shaft and being movable along the shaft; and
a passive member mounted pivotally on the seat, abutting the active member and driven by the active member to pivot and move the focusing device.

2. The automatic focusing camera base as claimed in claim 1, wherein:
the focusing device has an outer edge and a protruding block formed on the outer edge; and
the passive member has a pivot member formed on the passive member and mounted rotatably in the seat, a driven member formed on the passive member and pressing against the active member and a driving member formed on the passive member and pressing the protruding block of the focusing device.

3. The automatic focusing camera base as claimed in claim 2, wherein the shaft of the motor is a threaded shaft, and the active member is a nut mounted around on the threaded shaft and having a threaded hole defined through the nut and through which the threaded shaft is mounted.

4. The automatic focusing camera base as claimed in claim 3, wherein the seat further has a pivot seat formed on the seat and having a pivot slot defined in the pivot seat, and the pivot member of the passive member is mounted rotatably in the pivot slot in the pivot seat.

5. The automatic focusing camera base as claimed in claim 4, wherein:
the passive member is L-shaped and further has a first arm protruding from the pivot member and having a distal end, a second arm protruding from the pivot member and having a distal end and a space being between the first and second arms;
the driven member of the passive member is formed on the distal end of the first arm and the driving member of the passive member is formed on the distal end of the second arm; and
the active member further has a protrusion protruding from the active member and extending through the space between the first and second arms.

6. The automatic focusing camera base as claimed in claim 5 further comprising a cover mounted on the seat and covering the motor, the focusing device and the transmission device and having a lens hole defined through the cover.

7. The automatic focusing camera base as claimed in claim 6, wherein:
the cover has an opening defined through the cover; and
the focusing device further has an outside surface and a post formed on the outside surface opposite to the seat and extending through the opening and a spring mounted around the post and pressing against the cover.
